(19) United States
(12) Patent Application Publication
(10) Pub. No.: US 2013/0313187 A1
(43) Pub. Date: Nov. 28, 2013

(54) Resilient Ion Exchange Membranes

(71) Applicants: Xiangchun Yin, Coquitlam (CA); Zhongyuan Zhou, Vancouver (CA)

(72) Inventors: Xiangchun Yin, Coquitlam (CA); Zhongyuan Zhou, Vancouver (CA)

(73) Assignee: SALTWORKS TECHNOLOGIES INC., Vancouver, BC (CA)

(21) Appl. No.: 13/877,322

(22) PCT Filed: Oct. 4, 2011
(86) PCT No.: PCT/CA2011/001115

§ 371 Date: May 12, 2013

Related U.S. Application Data
(60) Provisional application No. 61/389,420, filed on Oct. 4, 2010.
(60) Provisional application No. 61/500,466, filed on Jun. 23, 2011.

(51) Int. Cl. C08J 5/22; B01D 67/00

(52) U.S. Cl. CPC C08J 5/2218; B01D 67/0002
USPC 210/500.33; 521/27; 427/331; 427/341; 427/517; 427/496; 427/385.5; 210/500.35; 210/500.38; 210/500.37

(57) ABSTRACT

A process for producing a resilient ion exchange membrane. The process comprises the steps of (1) selecting a porous matrix, (2) saturating the porous matrix with a homogenous solution comprising a mixture of: (i) a hydrophilic ionic monomer, (ii) a hydrophobic cross-linking oligomer and/or a comonomer, (iii) a free radical initiator, and (iii) a solvent for solubilizing the hydrophilic ionic monomer, the hydrophobic cross-linking oligomer and/or comonomer, and the free radical initiator into a homogenous mixture. (3) removing excess homogenous solution from the saturated porous matrix, (4) stimulating release of free radicals from the free radical initiator thereby initiating a polymerization reaction to form a cross-linked ion-transferring polymer substantially filling the pores and covering the surfaces of the porous matrix thereby forming a membrane, (5) washing the membrane to remove excess solvent, and (6) optionally bathing the washed membrane in a sodium chloride solution to selectively cross-link sodium or chloride ions to and within the ion-transferring polymer.

### FIELD OF THE INVENTION

This invention relates to ion-exchange membranes. More particularly, this invention relates to resilient ion exchange membranes able to withstand the formation of stress lines and/or fractures under operating conditions having stress-strain pressures.

### BACKGROUND

Ion-exchange membranes are used in a wide range of electrodialysis, electrolysis, and diffusion dialysis systems where selective transport of ions takes place under the influence of ion concentration gradients or electrical potential gradients as the driving force. The initial industrial applications of ion exchange membranes were focused on desalinization of saline water to produce potable water supplies. However, ion-exchange membranes are now widely used in many industrial and municipal applications exemplified by purification of drinking water, wastewater treatment, demineralization of amino acids, processing of whey waste streams, production of sugar liquors, de-salting diesel fuels, recovery of useful components from fluid process waste streams e.g., metal ions from electroplating systems, purification of organic substances, and the like.

Ion exchange membranes generally comprise a polymeric material to which are attached negatively charged ion groups, or alternatively, positively charged ion groups. The counterion of each group is the transferable ion. Anion exchange membranes are provided with positively charged groups bound to the polymeric material and have mobile negatively charged anions. Cation exchange membranes are provided with negatively charged groups fixed to the polymeric material and have mobile positively charged cations. Ion exchange membrane properties are generally determined by the amount, the type and the distribution of the fixed ionic groups. There are four categories of ion exchange membranes based on their ionic properties, i.e., strong acid membranes, strong base membranes, weak acid membranes, and weak base membranes. Strong acid membranes typically have sulfonic as the negative charged group, while weak acid membranes have carboxyl acid as the negative charged group. Strong base membranes generally have quaternary amines as the positive charged group, while weak base membranes have tertiary amines as the positive charged group. Ideally, a well-performing ion exchange membrane should have high ion selectivity, low electrical resistance, good mechanical properties, and high stability.

Electrodialysis systems transportions from a first solution to a second solution under the influence of an applied electric potential difference through a cation ion exchange membrane and an anion exchange membrane situated and fixed as the opposing walls of an electrodialysis cell. The cell consists of a “feed” compartment (also commonly referred to as a “diluate” compartment) and a “concentrate” compartment (also commonly referred to as a “brine” compartment) formed by an anion exchange membrane and a cation exchange membrane, each attached to an electrode. The anion exchange membrane and the cation exchange membrane are both impermeable to water molecules. Adjacent cells form a cell pair having: (i) a feed or diluting compartment, and (ii) a brine or concentrating compartment. For example, a water desalination electrodialysis cell pair would have a common cation exchange membrane separating the feed compartment and brine compartment. A first anion exchange membrane on one side of the cation exchange membrane provides and defines the outer surface of the feed i.e., the diluting cell. The first anion exchange membrane is attached to a first electrical terminal and will be an anode when an electrical charge is applied. A second anion membrane provides and defines the outer surface of the brine i.e., the concentrating cell. The second anion exchange membrane is attached to a second electrical terminal and will be cathode when an electrical charge is applied. In the diluting cell, cations will pass through the cation transfer membrane facing the anode (i.e., the first anion exchange membrane), but will be stopped by the paired anion transfer membrane of the concentrating cell in that direction facing the cathode (i.e., the second anion exchange membrane). Similarly, anions pass through the anion transfer membrane of the diluting cell facing the cathode, but will be stopped by the cation transfer of membrane of the adjacent pair facing the anode. In this manner, salt in a diluting cell will be removed and in the adjacent concentrating cell, cations will be entering from one direction and anions from the opposite direction.

The large throughput volumes required for commercial desalination processes generally require configuration of multiple electrodialysis cell pairs into an electrodialysis stack, with alternating anion and cation exchange membranes forming the multiple electrodialysis cells. Each membrane stack has a DC (direct current) anode at one end of the stack and a DC cathode at the other end. Under a DC voltage, ions move to the electrode of opposite charge. Flow in the electrodialysis stack is arranged so that the dilute and concentrated flows are kept separate and a desalinated water stream is produced from the dilute flow. Because the quantities of dissolved ions in feed streams are far less than ion concentrations in the brines, electrodialysis stacks facilitate high volume throughputs of fluids for desalination

Ionic salts commonly build up at the membrane surfaces in electrodialysis systems in the direction of electric flow thereby reducing the rates of ion flow through the membranes resulting in reduced desalination efficiencies and reduced throughput volumes. The accumulation of ions on the membrane surfaces can be overcome by periodically reversing the direction of ion flows by reversing the polarity of the electrodes on a regular basis thereby changing the “anode” membranes into “cathode” membranes and vice versa. The consequence is that the dilute and concentrate flows are simultaneously switched with the concentrate becoming the dilute flow and vice versa, enabling removal and flushing of ionic fouling deposits. This process is generally referred to as electrodialysis reversal (EDR) and is commonly used in most commercial electrodialysis systems.

Ion exchange membranes used in electrodialysis stacks for separation and/or recovery of ions from saline water, industrial processing liquid feedstocks and brines, are firmly fixed in place to prevent leakage of water between the cells and undergo considerable mechanical stress and strain due to considerable physical and hydrostatic pressures exerted during throughput and desalination of high volumes of fluids. Mechanical stresses and strains are exacerbated in systems that incorporate electrodialysis reversal. Repeated stress-strain pressure changes result in the occurrence of stress lines that result in membrane fractures and failures. Occurrence of stress lines in ion exchange membranes can also be caused by changes in osmotic pressure fluctuations as the concentrated brines receiving ions separated from fluids flowing through the diluant cells, and subsequently can result in membrane failures.

Most commercial ion exchange membranes are composite materials generally prepared by the copolymerization of a cross-linking divinyl monomer and a monomer containing ion exchange groups onto a selected membrane support material to overcome the problems of brittleness and poor mechanical stability associated with ion exchange resins. Membrane supports commonly used for manufacture of ion-exchange membranes include solid non-porous sheets of polyvinyl chloride (PVC) or low-density polyethylene (LDPE), and porous fabrics woven from PVC and/or LDPE strands. The cross-linked divinyl monomers and monomers having ion exchange groups can be applied to the membrane supports as poured-on or pasted-on coatings to impregnate the membrane supports. Alternatively, the ion-exchange membranes can be prepared by lamination of the membrane supports with divinyl monomers and ion exchange monomers followed by curing. However, the problem of ion-exchange membrane failure due to stress-strain pressures and/or osmotic fluctuations remains a significant industry concern.

Most commercially available ion exchange membranes are manufactured by multi-step processes using copolymers of styrene and divinylbenzene that are subsequently modified by addition of ion exchange moieties. The problem with ion exchange membranes comprising styrene divinylbenzene copolymers, particularly when they are further polymerized with compounds having short cross-linking chains, is that they tend to be brittle and non-resilient and consequently fracture under pressure and strain loads. Furthermore, the multi-step processes generally involve use of hazardous chemicals exemplified by styrene, divinylbenzene, concentrated sulfuric acid, and halogenated chemicals among others, and require elaborate safety precautions incorporated into the manufacturing facilities and waste stream handling systems to mitigate issues associated with worker health issues, and environmental toxicity. In addition to the need for more durable and more flexible ion-exchange membranes, there is also a concomitant need for producing such membranes using methods that are less toxic and more cost-effective.

### SUMMARY OF THE INVENTION

The embodiments of the present invention pertain to processes for producing resilient ion exchange membranes. Some embodiments pertain to resilient ion exchange membranes produced by the processes, that have durability to withstand stress-strain pressures during operational use.

An exemplary embodiment of the present invention pertains to a process for producing a resilient ion exchange membrane, that generally comprises the steps of (1) selecting a porous matrix, (2) saturating the porous matrix with a homogenous solution comprising mixture of: (i) a hydrophilic ionic monomer, (ii) a hydrophobic cross-linking oligomer and/or a comonomer, (iii) a free radical initiator, and (iii) a solvent selected for solubilizing the hydrophilic ionic monomer, the hydrophobic cross-linking oligomer and/or comonomer, and the free radical initiator into a homogenous mixture, (3) removing excess homogenous solution from the saturated porous matrix, (4) polymerizing the hydrophilic and hydrophobic components in the homogenous solution to form a cross-linked ion-transferring polymer that substantially fills the pores and substantially covers the surfaces of the porous matrix thereby producing the resilient ion exchange membrane of the present invention, (5) washing the resilient ion exchange membrane to remove excess solvent, and (6) optionally bathing the washed resilient ion exchange membrane in a sodium chloride solution to convert the ion exchange membrane into a sodium form or into a chloride form.

According to one aspect, the process produces resilient cation exchange membranes by incorporating into the homogenous solution hydrophilic ionic monomers selected from a group consisting of 2-acrylamido-2-methyl-1-propanesulfonic acid, sodium 4-vinylbenzenesulfonate, 3-sulfopropyl acrylate potassium, and their salts.

According to another aspect, the process produces resilient anion exchange membranes by incorporating into the homogenous solution hydrophilic ionic monomers selected from a group consisting of 3-methacryloylaminopropyl trimethylammonium chloride, vinylbenzyl trimethylammonium, 3-acrylamidopropyl trimethylammonium chloride, 2-acryloyloxyethyl trimethylammonium chloride, 3-methacryloylaminopropyl trimethylammonium chloride, and mixtures thereof.

According to another aspect, the process produces resilient ion exchange membranes by incorporating into the homogenous solution one or more hydrophobic cross-linking oligomers and/or comonomers selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, and their dimethacrylate counterparts thereof, and mixtures thereof. Alternatively, the hydrophobic cross-linking oligomers and/or comonomers may be selected from a group consisting of polyurethane oligomers having three or more reactive vinyl groups, polyester oligomers having three or more reactive vinyl groups, polyether oligomers having three or more reactive vinyl groups, counterparts thereof, and mixtures thereof.

Another embodiment of the present invention pertains to a resilient cation exchange membrane comprising: (1) a porous matrix selected from a group consisting of polyesters, polyvinyl chlorides, low-density polyethylenes, very-low-density polyethylenes, polypropylenes, polysulfones, nylons, nylon-polyamides, and mixtures thereof; to which are cross-linked (2) a hydrophilic ionic monomer selected from a group consisting of 2-acrylamido-2-methyl-1-propanesulfonic acid, sodium 4-vinylbenzenesulfonate, 3-sulfopropyl acrylate potassium, and salts thereof; and (3) a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, and their dimethacrylate counterparts thereof, and mixtures thereof, and mixtures thereof. Alternatively, the hydrophobic cross-linking oligomers and/or comonomers may be selected from a group consisting of polyurethane oligomers having three or more reactive vinyl groups, polyester oligomers having three or more reactive vinyl groups, polyether oligomers having three or more reactive vinyl groups, counterparts thereof, and mixtures thereof. The resilient cation exchange membranes of the present invention generally have the following properties: (i) a membrane thickness in the range of about 0.06 mm to about 0.15 mm; (ii) an electrical resistance in the range of about 0.8 Ωcm² to about 3.0 Ωcm²; (iii) a water content in the range of about 20% to about 45% by wt.; and (iv) an ion exchange capacity from the range of about 1.3 mmol to about 2.5 mmol per g of dry resin.

Another embodiment of the present invention pertains to a resilient anion exchange membrane comprising: (1) a porous matrix selected from a group consisting of polyesters, polyvinyl chlorides, low-density polyethylenes, very-low-density polyethylenes, polypropylenes, polysulfones, nylons, nylon-polyamides, and mixtures thereof; to which are cross-linked (2) a hydrophilic ionic monomer selected from a group consisting of 3-methacryloylaminopropyl trimethylammonium chloride, vinylbenzyl trimethylammonium, 3-acrylamidopropyl trimethylammonium chloride, 2-acryloyloxyethyl trimethylammonium chloride, 3-methacryloylaminopropyl trimethylammonium chloride, and mixtures thereof; and (3) a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, and their dimethacrylate counterparts thereof, and mixtures thereof, and mixtures thereof. Alternatively, the hydrophobic cross-linking oligomers and/or comonomers may be selected from a group consisting of polyurethane oligomers having three or more reactive vinyl groups, polyester oligomers having three or more reactive vinyl groups, polyether oligomers having three or more reactive vinyl groups, counterparts thereof, and mixtures thereof. The resilient anion exchange membranes of the present invention generally have the following properties: (i) a membrane thickness in the range of about 0.06 mm to about 0.15 mm; (ii) an electrical resistance in the range of about 0.8 Ωcm² to about 3.0 Ωcm²; (iii) a water content in the range of about 20% to about 45% by wt.; and (iv) an ion exchange capacity from the range of about 1.3 mmol to about 2.5 mmol per g of dry resin.

### DESCRIPTION OF THE DRAWINGS

The present invention will be described in conjunction with reference to the following drawing in which:

FIG. 1 is a chart showing desalination of a salt solution by passage through an electrodialysis microstack assembled with exemplary anion exchange membranes and exemplary cation exchange membranes according to one embodiment of the present invention.

### DETAILED DESCRIPTION OF THE INVENTION

The embodiments of the present invention relate to processes for producing resilient ion exchange membranes that have excellent mechanical stability in that they are flexible and resistant to the formation of stress lines, fractures, and the occurrence of cracking during use. The embodiments also relate to resilient ion exchange membranes produced by the processes of the present invention.

An embodiment of the present invention pertains to a process for producing an exemplary flexible ion exchange membrane having resilient deformation properties that resist the formation of stress lines and/or fractures across and through the membrane's inner and outer surfaces. The process comprises the steps of preparing a homogenous solution comprising a mixture of: (i) one or more hydrophilic ionic monomer components, (ii) one or more hydrophobic long-chain cross-linking oligomer components and/or one or more hydrophobic cross-linking comonomer components, (iii) a free radical initiator, and (iv) one or more solvents that have the capacity to solubilise the hydrophilic components, the hydrophobic components, and the free radical initiator, and then keep components solubilised in a homogenous solution without their separation into hydrophilic and hydrophobic phases. A suitable porous matrix is saturated with the homogenous solution after which, excess solution is removed while taking measures to avoid formation of air pockets and/or bubbles, resulting in the porous matrix being impregnated by the homogenous solution and with both surfaces of the porous matrix being coated by a film of the homogenous solution. The impregnated and coated porous structure is cured by activation of the free radical initiator consequently resulting in formation of a homogenous polymeric gel within, throughout, and about the porous matrix without the occurrence of any macrophase separation of the hydrophilic and hydrophobic components, thereby producing the flexible and resilient membrane. The resilient ion exchange membrane is then washed to remove excess solvent, and may be optionally bathed in a sodium chloride solution.

The resilient ion exchange membranes produced by the process of the present invention comprise porous substrates impregnated with and covered by homogenous polymeric gels within, throughout, and about the substrates. The water content of the resilient ion exchange membranes can be adjusted to within selected target ranges by adjusting the concentrations of the solvents in the homogenous solutions used to prepared the ion exchange membranes.

According to one aspect, the porous matrix may comprise a woven fabric, a non-woven sheet material, or a microporous substrate.

Suitable woven fabrics may be woven from strands selected from one or more of materials exemplified by polyester, PVC, LDPE, very-low-density polyethylene (VLDPE), polypropylene, polysulfone, nylon, nylon-polyamides. Suitable polyesters are exemplified by polyglycolide or polyglycolic acid (PGA), polylactic acid (PLA), polycaprolactone (PCL), polyethylene adipate (PEA), polyhydroxyalkanoate (PHA), polyethylene teraphthalate (PET), polybutylene teraphthalate (PBT), polytrimethylene teraphthalate (PTT), polyethylene naphthalate (PEN), and Vectran®, a fiber spun from a liquid crystal polymer formed by the polycondensation of 4-hydroxybenzoic acid and 6-hydroxynaphthalene-2-carboxylic acid (Vectran is a registered trademark of Kuraray Co. Ltd., Kurashiki City, Japan). PET is particularly suitable for producing a woven fabric matrix for the flexible ion exchange membrane of the present invention.

Suitable non-woven sheet material may comprise sections of a single sheet comprising a material exemplified by polyester, PVC, LDPE, VLDPE, polypropylene, polysulfone, nylon, nylon-polyamides. Suitable polyesters are exemplified by polyglycolide or PGA, PLA, PCL, PEA, PHA, PET, PBT, PTT, and PEN. Also suitable is a sheet material that comprising two or more laminations of combinations of sheet material exemplified by PVC, LDPE, VLDPE, polypropylene, polysulfone, nylon, nylon-polyamides. Suitable polyesters are exemplified by polyglycolide or PGA, PLA, PCL, PEA, PHA, PET, PBT, PTT, and PEN.

Suitable microporous sheet material may comprise sections of a single sheet microporous matrix comprising a material exemplified by polyester, PVC, LDPE, VLDPE, polypropylene, polysulfone, nylon, nylon-polyamides. Suitable polyesters are exemplified by polyglycolide or PGA, PLA, PCL, PEA, PHA, PET, PBT, PTT, and PEN.

Another embodiment of the present invention pertains to homogenous solutions for preparing the resilient ion exchange membranes of the present invention that comprise selected porous matrices as the membrane substrates. The homogenous solutions comprise mixtures of one or more hydrophilic ionic monomer components, one or more hydrophobic cross-linking oligomer components and/or comonomer components, and one or more free radical initiators, wherein all of the components are solubilised in a solvent or mixture of solvents that are capable of maintaining the components in a homogenous solutions without any separation into hydrophilic and hydrophobic phases.

One aspect pertains to hydrophilic ionic monomers that are suitable for incorporation into the homogenous solution used to impregnate the porous matrix.

Suitable hydrophilic ionic monomers for preparing cation exchange membranes are exemplified by 2-acrylamido-2-methyl-1-propanesulfonic acid (AMPS) and its salts, sodium 4-vinylbenzenesulfonate and its salts, and 3-sulfopropyl acrylate potassium and its salts. Sodium 4-vinylbenzenesulfonate also known by its tradenames Kayexelate, Resonium A, and Kionex® (Kionex is a registered trademark of Paddock laboratories Inc., Minneapolis, Minn., USA).

Suitable hydrophilic ionic monomers for preparing anion exchange membranes are exemplified by 3-methacryloylaminopropyl trimethylammonium chloride (MAPTAC), vinylbenzyl trimethylammonium, 3-acrylamidopropyl trimethylammonium chloride, 2-acryloyloxyethyl trimethylammonium chloride, and 3-methacryloylaminopropyl trimethylammonium chloride.

Another aspect pertains to selected hydrophobic cross-linking oligomers and comonomers that are suitable for incorporation into the homogenous solution used to impregnate and overlay the porous matrix. The function of the hydrophobic cross-linking oligomers and/or comonomers is to increase the ductility of the ion exchange resins thereby allowing absorption of the energy of deformation and resulting in an ion exchange membrane that resiliently deforms under a stress and/or a strain pressure instead of forming a stress line and/or fracturing. More specifically, membranes that are cross-linked with hydrophobic oligomers and/or comonomers have a relatively low Young's modulus that improves the membranes' resilience while also increasing their toughness when exposed to stress pressures and/or strain pressures. Suitable hydrophobic cross-linking oligomers and comonomers preferably have two vinyl bonds as exemplified by polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, and their dimethacrylate counterparts thereof, and mixtures thereof. Also suitable are hydrophobic cross-linking oligomers and comonomers that have multiple vinyl functionalities as those exemplified by tetrafunctional epoxy acrylate oligomers (e.g., product number CN2204, Sortomer USA LLC, Exton, Pa., USA), hexafunctional aliphatic urethane acrylates (e.g., product number CN9006, Sortomer USA LLC), trifunctional aliphatic urethane acrylates (e.g., product number CN989, Sortomer USA LLC), multifunctional urethane acrylate oligomers (e.g., product number CN9013, Sortomer USA LLC), and the like.

Another aspect pertains to selection of free radical initiators for addition into the homogenous solutions of the present invention. There are three phases that occur during cross-linking polymerization reactions: (i) stimulation/initiation of the release of free radicals from the free radical initiator compound to catalyze a polymerization reaction between monomers and oligomers and/or comonomers, (ii) propagation of the polymerization reaction, and (iii) termination of the polymerization reaction. The rate of reaction during the first step is dependent on the chemical composition of the free radical initiator and the energy intensity of the stimulus that initiates the rapid release of free radicals that subsequently react with the vinyl groups of the hydrophobic cross-linkers to initiate the polymerization process The rates of reaction of the later steps of propagation and termination of the polymerization reaction are a function of vinyl bond concentrations in the oligomers and/or comonomers, and the rate constants for the propagation and termination reactions. Common forms of stimuli used to initiate the release of free radicals from free radical initiators are exemplified by UV photoinitiation, thermal initiation, addition of a material to initiate a redox reaction to release free radicals, and radiation with electron beams. Particularly suitable are free radical initiators stimulated to release free radicals by irradiation with UV light (i.e., photoinitiators) or by thermal radiation (i.e., thermal initiators).

Suitable free radical initiators that release free radicals upon exposure to UV light are exemplified by α-hydroxy ketones free radical initiators, benzoin ethers, benzil ketals, α-dialkoxy acetophenones, α-hydroxy alkylphenones, α-amino alkylphenones, acylphosphine oxides, benzophenons/amines, thioxanthone/amines, and titanocenes. Suitable α-hydroxy ketone free radical initiators are exemplified by 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, -hydroxy-cyclohexyl-phenyl-ketone:benzophenone, and mixtures thereof. Suitable free radical free radical initiators are exemplified 2,2′-Azobis(2-methylpropionitrile), benzoyl peroxide, 1,7-bis(9-acridinyl)heptane, 2-hydroxy-[4′-(2-hydroxypropoxy)phenyl]-2-methyl propanone, 4,4′bis(diethylamino)benzophenone, 4,4′,4″-methylidynetris(N,N-dimethylaniline), 2-hydroxy-2-methyl-1-(4-tert-butyl)phenyl propanone, 2-Benzyl-2-(dimethylamino)-4′-morpholinobutyrophenone, 1-hydroxycyclohexyl phenylketone, 2-methyl-1-[4-(methylthio)phenyl]-2-morpholinopropan-1-one, 4-methylbenzophenone, 4-phenylbenzophenone, 2-hydroxy-2-methyl-1-phenylpropanone, 2,2′-bis-(2-chlorophenyl), 4′,5,5′-tetraphenyl-1,2′biimidazole, 2,2-Dimethyoxy-2-phenylacetophenone, 4-benzoyl-4′-methyldiphenylsulphide, benzophenone, 2-chlorothioxanthone, 2,4-diethylthioxanthone, 2-isopropylthioxanthone, methyl benzoylformate, methyl-o-benzoylbenzoate, 2,4,6-trimethylbenzoyl-diphenyl phosphine oxide, ethyl(2,4,6-Trimethylbenzoyl)-phenyl phosphinate, and mixtures thereof.

Suitable free radical thermal initiators that release free radicals upon exposure to thermal radiation are exemplified by azo-compound thermal initiators and by peroxide-compound thermal initiators. Suitable azo-compound thermal initiators are exemplified by 1,1′-azobis(cyclohexanecarbonitrile), 2,2′-azobis(isobutyronitrile), 2,2′-azobis(4-methoxy-2,4-dimethyl valeronitrile), 2,2′-azobis(2,4-dimethyl valeronitrile), dimethyl 2,2′-azobis(2-methylpropionate), and the like. Suitable peroxide-compound thermal initiators are exemplified by tert-amyl peroxybenzoate, benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peroxide, tert-butyl peracetate, cyclohexanone peroxide, dicumyl peroxide, lauroyl peroxide, and the like.

Suitable solvents for preparing a resilient cation exchange membrane using homogenous solution comprising a hydrophilic ionic monomer, a hydrophobic cross-linking oligomer and/or a comonomer, and a free radical initiator, are exemplified by a mixture of dimethylacetamide and tributylamine at a ratio of about 1:3 to about 5:1, a mixture of, dimethylacetamide and trialkylamine at a ratio of about 1:3 to about 5:1, a mixture of dimethylacetamide and dialkylamine at a ratio of about 1:3 to about 5:1, and a mixture of dimethylacetamide and monoalkylamine at a ratio of about 1:3 to about 5:1. Particularly suitable is a mixture of dimethylacetamide and tributylamine at a ratio of about 1:3 to about 5:1. Also suitable is dimethylacetamide at a concentration of about 20% by weight of the homogenous solution to about 45% by weight of the homogenous solution.

Suitable solvents for preparing a resilient anion exchange membrane using homogenous solution comprising a hydrophilic ionic monomer, a hydrophobic cross-linking oligomer and/or a comonomer, and a free radical initiator, are saturated aliphatic fatty acids exemplified by butyric acid, valeric acid, caprylic acid, capric acid, hexanoic acid, lauric acid, palmitic acid, stearic acid, arachidic acid, behenic acid, and mixtures thereof. The concentration for the saturated aliphatic acid should be in the range of about 23% by weight of the homogenous solution to about 48% by weight of the homogenous solution. Also suitable solvents for producing the resilient anion exchange membranes of the present invention are diethylene glycol, diethylene glycol methyl esters, and mixtures thereof. Particularly suitable are mixtures of diethylene glycol and diethylene glycol methyl esters at a ratio of about 1:1.15 to about 2:1, wherein the concentration of the diethylene glycol:diethylene glycol methyl ester mixture in the homogenous solution is from a range of 32% by weight to about 42% by weight.

An exemplary process for producing a resilient cation ion exchange membrane comprises:
1) preparing a homogenous solutions comprising: (i) about 15% to about 35% of a suitable hydrophilic ionic monomer, (i) about 30% to about 65% of one or more suitable hydrophobic cross-linking oligomers and/or hydrophobic cross-linking comonomers, (iii) about 17% to about 45% of one or more suitable solvents, and (iv) about 0.75% to about 10% of a free radical initiator;
2) saturating a porous matrix with the homogenous solution, then removing excess solution thereby producing a porous matrix impregnated with and covered by a film of the homogenous solution;
3) curing the impregnated porous matrix by activating the free radical initiator thereby causing formation of a homogenous polymeric gel within, throughout, and about the porous matrix thereby forming a resilient ion exchange membrane; and
4) washing the ion exchange membrane to remove excess solvent, then bathing the membrane in a sodium chloride solution to convert the membrane into a sodium form thereby producing a resilient cation exchange membrane of the present invention.

Another exemplary process for producing a resilient cation ion exchange membrane comprises:
1) preparing a homogenous solutions comprising: (i) about 20% to about 30% of a suitable hydrophilic ionic monomer, (i) about 35% to about 60% of one or more suitable hydrophobic cross-linking oligomers and/or hydrophobic cross-linking comonomers, (iii) about 20% to about 35% of one or more suitable solvents, and (iv) about 1.0% to about 2.5% of a free radical initiator;
2) saturating a porous matrix with the homogenous solution, then removing excess solution thereby producing a porous matrix impregnated with and covered by a film of the homogenous solution;
3) curing the impregnated porous matrix by activating the free radical initiator thereby causing formation of a homogenous polymeric gel within, throughout, and about the porous matrix thereby forming a resilient ion exchange membrane; and
4) washing the ion exchange membrane to remove excess solvent, then bathing the membrane in a sodium chloride solution to convert the membrane into a sodium form thereby producing a resilient cation exchange membrane of the present invention.

An exemplary process for producing a resilient anion exchange membrane comprises:
1) preparing a homogenous solutions comprising: (i) about 15% to about 35% of a suitable hydrophilic ionic monomer, (i) about 30% to about 45% of one or more suitable hydrophobic cross-linking oligomers and/or hydrophobic cross-linking comonomers, (iii) about 20% to about 45% of one or more suitable solvents, and (iv) about 0.75% to about 10% of a free radical initiator;
2) saturating a porous matrix with the homogenous solution, then removing excess solution thereby producing a porous matrix impregnated with and covered by a film of the homogenous solution;
3) curing the impregnated porous matrix by activating the free radical initiator thereby causing formation of a homogenous polymeric gel within, throughout, and about the porous matrix thereby forming a resilient ion exchange membrane; and
4) washing the ion exchange membrane to remove excess solvent, then bathing the membrane in a sodium chloride solution to convert the membrane into a chloride form thereby producing a resilient anion exchange membrane of the present invention.

Another exemplary process for producing a resilient anion exchange membrane comprises:
1) preparing a homogenous solutions comprising: (i) about 20% to about 30% of a suitable hydrophilic ionic monomer, (i) about 35% to about 40% of one or more suitable hydrophobic cross-linking oligomers and/or hydrophobic cross-linking comonomers, (iii) about 25% to about 40% of one or more suitable solvents, and (iv) about 1.0% to about 2.5% of a free radical initiator;
2) saturating a porous matrix with the homogenous solution, then removing excess solution thereby producing a porous matrix impregnated with and covered by a film of the homogenous solution;
3) curing the impregnated porous matrix by activating the free radical initiator thereby causing formation of a homogenous polymeric gel within, throughout, and about the porous matrix thereby forming a resilient ion exchange membrane; and
4) washing the ion exchange membrane to remove excess solvent, then bathing the membrane in a sodium chloride solution to convert the membrane into a chloride form thereby producing a resilient anion exchange membrane of the present invention.

The resilient cation exchange membranes of the present invention have the following characteristics:
(i) membrane thickness in the range of about 0.06 mm to about 0.15 mm, of about 0.8 mm to about 0.13 mm, of about 0.9 mm to about 0.12 mm;
(ii) electrical resistance in the range of about 0.8 Ωcm² to about 3.0 Ωcm², from about 1.0 to about 2.5 Ωcm², from about 1.1 Ωcm² to about 2.1 Ωcm²;
(iii) water content in the range of about 20% to about 45% by wt., from about 25 to about 40% by wt., from about 29% to about 36% by wt.; and
(iv) ion exchange capacity from the range of about 1.3 mmol to about 2.5 mmol per g of dry resin, 1.5 mmol to about 2.2 mmol per g of dry resin, 1.8 mmol to about 2.0 mmol per g of dry resin.

The resilient anion exchange membranes of the present invention have the following characteristics:
(i) membrane thickness in the range of about 0.06 mm to about 0.15 mm, of about 0.8 mm to about 0.13 mm, of about 0.9 mm to about 0.12 mm;
(ii) electrical resistance in the range of about 0.8 Ωcm² to about 3.0 Ωcm², from about 1.0 to about 2.5 Ωcm², from about 1.1 Ωcm² to about 2.1 Ωcm²;
(iii) water content in the range of about 20% to about 45% by wt., from about 25 to about 40% by wt., from about 29% to about 36% by wt.; and
(iv) ion exchange capacity from the range of about 1.3 mmol to about 2.5 mmol per g of dry resin, 1.5 mmol to about 2.2 mmol per g of dry resin, 1.8 mmol to about 2.0 mmol per g of dry resin.

The resilient ion exchange membranes of the present invention are durable under fluctuating stress-strain pressure conditions, and are particularly suitable for applications such as those exemplified by desalinization of saline water, purification of drinking water, wastewater treatment, demineralization of amino acids, processing of whey waste streams, production of sugar liquors, de-salting diesel fuels, purification of organic substances, recovery of useful components from fluid process waste streams e.g., recovery metal ions from electroplating systems, among others.

The present invention will be further illustrated in the following examples. However it is to be understood that these examples are for illustrative purposes only, and should not be used to limit the scope of the present invention in any manner.

### EXAMPLES

### Example 1

### Preparation of an Exemplary Cation Exchange Membrane

A solvent solution was prepared by mixing together 152 g of dimethylacetamide with 152 g of tributylamine. 304 g of the hydrophilic monomer 2-acrylamido-2-methyl-1-propanesulfonic acid (AMPS) was mixed into the dimethylacetamide/tributylamine solvent solution and dissolved. 228 g of hydrophobic cross-linking polyurethane oligomer diacrylate was diluted with 228 g of comonomer hexanediol diacrylate, and then was added to the solvent solution already containing the AMPS component. The mixture was stirred to form a homogenous solution after which, 15 g of the photoinitiator Irgacure® 2959 (Irgacure is a registered trademark of CIBA Specialty Chemicals Corp., Tarrytown, N.Y., USA) was added and dissolved in the solvent mixture comprising the hydrophilic monomer and the hydrophobic cross-linking oligomers and comonomers. The complete homogenous solution was applied onto a woven fabric comprising SEFAR® PET 1500 having the following physical properties: (i) mesh size 151 μm, (ii) open area 53%, and (iii) mesh thickness 90 μm (SEFAR is a registered trademark of Sefar Holding AG, Thal, Switzerland). Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in water and was then placed in 10% NaCl solution to enable ion exchange to convert the membrane into a sodium form, thereby converting the ion exchange membrane into a cation exchange membrane. The cation exchange membrane had the following properties:

Membrane thickness: 0.09 mm-0.10 mm

Electrical resistance: 2.1-2.5 Ωcm²

Water content: 29-31 wt %

Ion exchange capacity: 1.9 mmol per gram of dry resin

### Example 2

### Preparation of an Exemplary Cation Exchange Membrane Using a Single Solvent System

304 g of AMPS was mixed with 304 g of tributylamine solvent (1:1). It was not possible to completely dissolve AMPS in the tributylamine solvent i.e., this mixture did not form a homogenous solution. Subsequently, 200 g of AMPS was mixed with 304 g of tributylamine solvent (1:1.5). It was not possible to completely dissolve AMPS in the tributylamine solvent i.e., this mixture did not form a homogenous solution. Accordingly, it was determined that preparation of a cation exchange membrane having AMPS as the hydrophilic ion exchange component required the addition of dimethylacetamide to the solvent solution.

### Example 3

### Preparation of an Exemplary Anion Exchange Membrane

To 360 g of hexanoic acid was added 201 g of the hydrophilic monomer 3-methacryloylaminopropyl trimethylammonium chloride (MAPTAC) and was gently stirred until the MAPTAC was dissolved. 394 g of the hydrophobic cross-linking oligomer polyurethane oligomer diacrylate was diluted with 394 g of hydrophobic cross-linking comonomer hexanediol diacrylate, and then stirred into the MAPTAC solution. After the mixture had dissolved into a homogenous solution, 15 g of Irgacure® 2959 was then stirred into and dissolved in the homogenous solution. The homogenous solution was applied onto a woven fabric comprising SEFAR® PET 1500 having the same properties disclosed in Example 1. Excess solution was removed from the substrate by running a roller over the substrate with care being taken to exclude air bubbles from the substrate. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in methanol to remove hexanoic acid solvent, and then was placed in 10% NaCl solution to enable ion exchange to convert the membrane into a chloride form, thereby converting the ion exchange membrane into an anion exchange membrane. The anion exchange membrane had the following properties:

Membrane thickness: 0.09-0.10 mm

Electrical resistance: 1.5-2.0 Ωcm²

Water content: 36-40 wt %

Ion exchange capacity: 1.6 mmol per gram of dry resin

### Example 4

### Electrodialysis Performance of Paired Cation Exchange Membranes and Anion Exchange Membranes

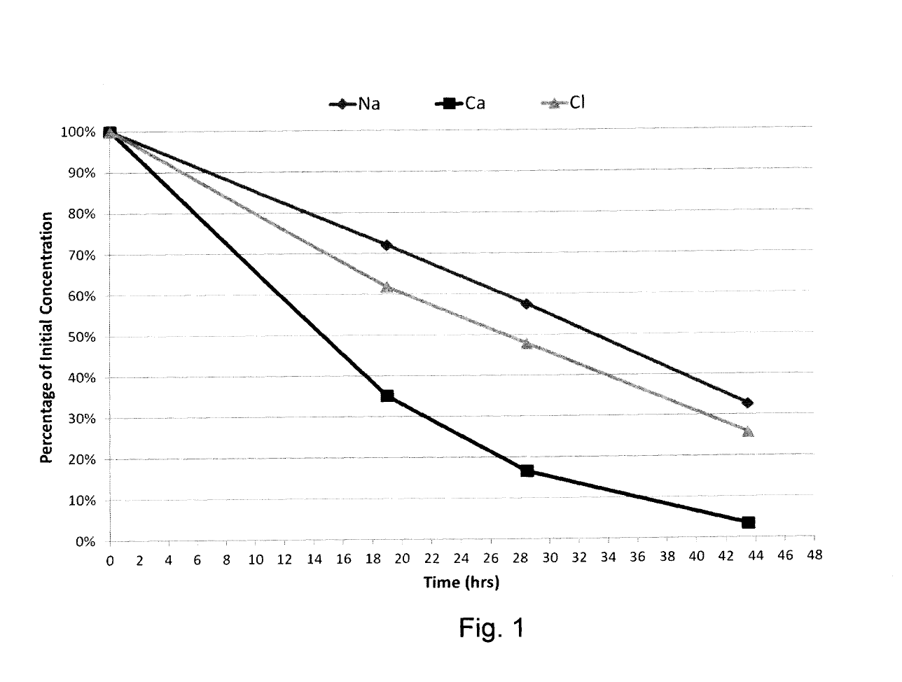

A 24-cell electrodialysis microstack was assembled with cell pairs comprising alternating 3-inch by 3-inch sheets of the cation exchange membranes produced in Example 1 and the anion exchange membranes prepared in Example 3. A salt solution comprising a mixture of CaCl₂ and NaCl (30 mS/cm, ˜18,000 mg/L TDS) was passed in parallel through the dilute/feed chambers and the brine/concentrate chambers of the electrodialysis microstack at a rate of about 0.4 liter per hour. A direct current of 50-90 mA was applied between the electrodes. Ion concentrations in the dilute stream exiting the electrodialysis microstack were measured after 19 hrs, 28 hrs and 44 hrs of operation. The data in FIG. 1 show that the concentrations of all three ions, i.e., sodium, chloride and calcium, decreased steadily throughout the 44-hr monitoring period.

### Example 5

### Diffusion Dialysis in a Diffusion Dialysis Stack Equipped with Anion Exchange Membranes

A 22-cell diffusion dialysis microstack was assembled with cell pairs comprising the anion exchange membranes prepared in Example 3. A salt solution comprising a mixture of HCL (17 mg/mL) CaCl₂ (24.3 mg/mL) and NaCl (4.3 mg/mL) was passed through the feed chambers and while de-ionized water was passed through the product chambers of the diffusion dialysis microstack at a rate of about 0.4 liter per hour. The pH and the conductivity of the feed solution and the product solution exiting the diffusion dialysis microstack were measured time 0, after 3 hrs, and 40 hrs of operation. The data in Table 1 shows the pH and the conductivity of the feed solution and the product solution during the 40-hr time period. Due to diffusion of the HCL from the feed side to the product side of the cell pairs, the pH of the outgoing feed flow increased while its conductivity decreased, while the pH of the outgoing product flow decreased and its conductivity increased. Ion analyses showed that there no calcium ions were present and only trace amounts of sodium ions were present in the final solution of product flow.

TABLE 1

| | Feed solution | | Product solution | |
|---|---|---|---|---|
| Time | pH | conductivity (mS/cm) | pH | conductivity (mS/cm) |
| 0 | 0.2 | 206 | 5.3 | 0.1 |
| 3 hr | 0.4 | 189 | 1.5 | 14 |
| 40 hr | 0.5 | 117 | 0.5 | 110 |

### Example 6

### Regeneration of a Fouled Exemplary Ion Exchange Membrane

After extended use in electrodialysis systems, cation exchange membranes generally become fouled by the accumulation of divalent and/or multivalent mineral ions about the membrane surfaces. Fouling of the cation exchange membrane produced in Example 1 was simulated by submersing and soaking the cation exchange membrane in a 5% CaCl₂ solution for 24 hr. The electrical resistance of the membrane increased from 2.2 Ωcm² prior to soaking to 8.5 Ωcm² after 24 hr of soaking in CaCl₂ indicating that the membrane was fouled by the calcium ions. The fouled membrane was then submersed and soaked in a 3M NaCl solution for 1 hr after which it was removed and its electrical resistance measured again. The electrical resistance was 2.2 Ωcm² indicating that the cation exchange membrane had been regenerated to its original condition.

### Example 7

### Preparation of an Exemplary Cation Exchange Membrane

To 304 g of the solvent dimethylacetamide (DMAc) was added 304 g of AMPS and was gently stirred until the AMPS was dissolved. Then, 380 g of the hydrophobic cross-linking comonomer hexanediol diacrylate was stirred into the AMPS/DMAc solution. After the hexanediol diacrylate was dissolved, 15 g of Irgacure® 2959 was then stirred into and dissolved in the homogenous solution. The homogenous solution was applied onto a 90-μm thick non-woven polypropylene substrate sheet with 80% porosity (DelStar Technologies Inc., Middleton, Del., USA). Excess homogenous solution was removed from the non-woven porous substrate sheet by running a roller over the sheet with care taken to remove and exclude air bubbles thereby producing a non-woven substrate impregnated with and covered by a film of the homogenous solution. The impregnated non-woven substrate was then irradiated with UV light (wavelength 300-400 nm) for 8 min to initiate polymerization of the hydrophilic monomer and the hydrophobic cross-linking comonomer, resulting in the formation of a homogenous polymeric gel within, throughout, and about the non-woven substrate forming a homogenous membrane structure. The resulting membrane was rinsed thoroughly in water and was then placed in 10% NaCl solution to enable ion exchange to convert the membrane into a sodium form, thereby converting the ion exchange membrane into a cation exchange membrane. The cation exchange membrane had the following properties:

Membrane thickness: 0.10 mm-0.12 mm

Electrical resistance: 1.1-1.5 Ωcm²

Water content: 29-31 wt %

Ion exchange capacity: 2.1 mmol per gram of dry resin

### Example 8

### Preparation of an Exemplary Cation Exchange Membrane

To 330 g of the solvent dimethylacetamide (DMAc) was added 252 g of AMPS and was gently stirred until the AMPS was dissolved. Then, 205 g of hydrophobic cross-linking comonomer hexanediol diacrylate was diluted with 195 g of the cross-linking comonomer decanediol diacrylate and then stirred into the AMP S/DMAc solution. After a homogenous solution was formed, 18 g of Irgacure® 2959 was then stirred into and dissolved in the homogenous solution. The homogenous solution was applied onto a 100-μm thick microporous polyethylene membrane with 82% porosity (Lydall Filtration/Separation Inc., Rochester, N.H., USA). Excess homogenous solution was removed from the microporous membrane by running a roller over the membrane with care taken to remove and exclude air bubbles thereby producing a microporous polyethylene membrane impregnated with and covered by a film of the homogenous solution. The impregnated microporous polyethylene membrane was irradiated with UV light (wavelength 300-400 nm) for 8 min to initiate polymerization of the hydrophilic monomer and the hydrophobic comonomer, resulting in the formation of a homogenous polymeric gel within, throughout, and about the microporous substrate forming a homogenous membrane structure. The resulting membrane was rinsed thoroughly in water to remove excess DMAc and was then placed in 10% NaCl solution to enable ion exchange to convert the membrane into a sodium form, thereby converting the ion exchange membrane into a cation exchange membrane. The cation exchange membrane had the following properties:

Membrane thickness: 0.12 mm

Electrical resistance: 2.0 Ωcm²

Water content: 30-33 wt %

Ion exchange capacity: 2.3 mmol per gram of dry resin

### Example 9

### Preparation of an Exemplary Cation Exchange Membrane

To 231 g of the solvent dimethylacetamide (DMAc) was added 231 g of AMPS and was gently stirred until the AMPS was dissolved. Then, a mixture was prepared by stirring together 327 g of hydrophobic comonomer hexanediol diacrylate and 83 g of the hydrophobic comonomer laurel acrylate. The mixture of hydrophobic comonomers as added into the AMPS/DMAc solution and stirred until a homogenous solution was formed. Then, 18 g of Irgacure® 2959 was stirred into and dissolved in the homogenous solution. The homogenous solution was applied onto a 90-μm thick non-woven polypropylene substrate sheet with 80% porosity (DelStar Technologies Inc.). Excess homogenous solution was removed from the non-woven porous substrate sheet by running a roller over the sheet with care taken to remove and exclude air bubbles thereby producing a non-woven substrate impregnated with and covered by a film of the homogenous solution. The impregnated non-woven substrate was then irradiated with UV light (wavelength 300-400 nm) for 8 min to initiate polymerization of the hydrophilic monomer and the hydrophobic comonomers, resulting in the formation of a homogenous polymeric gel within, throughout, and about the non-woven substrate forming a homogenous membrane structure. The resulting membrane was rinsed thoroughly in water to remove excess DMAc and was then placed in 10% NaCl solution to enable ion exchange to convert the membrane into a sodium form, thereby converting the ion exchange membrane into a cation exchange membrane. The cation exchange membrane had the following properties:

Membrane thickness: 0.09-0.12 mm

Electrical resistance: 1.5-2.0 Ωcm²

Water content: 30-33 wt %

Ion exchange capacity: 1.7 mmol per gram of dry resin

### Example 10

### Preparation of an Exemplary Anion Exchange Membrane

To a solvent solution comprising a mixture of 169 g of diethylene glycol and 213 g of diethylene glycol methyl ether was added 212 g of the hydrophilic monomer vinylbenzyl trimethylammonium chloride (VBTAC), and was gently stirred until the VBTAC was completely dissolved. Then, 396 g of the hydrophobic cross-linking comonomer hexanediol diacrylate was added to the VBTAC solvent solution and stirred until the hexanediol diacrylate was dissolved and a homogenous solution was formed. 10 g of Irgacure® 2959 was then stirred into and dissolved in the homogenous solution. The homogenous solution was applied onto a 90-μm thick non-woven polypropylene substrate sheet with 80% porosity (DelStar Technologies Inc.). Excess homogenous solution was removed from the non-woven porous substrate sheet by running a roller over the sheet with care taken to remove and exclude air bubbles thereby producing a non-woven substrate impregnated with and covered by a film of the homogenous solution. The impregnated non-woven substrate was irradiated with UV light (wavelength 300-400 nm) for 10 min to initiate polymerization of the hydrophilic monomer and the hydrophobic comonomer, resulting in the formation of a homogenous polymeric gel within, throughout, and about the non-woven substrate forming a homogenous membrane structure. The resulting membrane was rinsed thoroughly in water to remove excess diethylene glycol and diethylene glycol methyl ether, and then was placed in 10% NaCl solution to enable ion exchange to convert the membrane into a chloride form, thereby converting the ion exchange membrane into an anion exchange membrane. The anion exchange membrane had the following properties:

Membrane thickness: 0.09-0.12 mm

Electrical resistance: 1.1-1.5 Ωcm²

Water content: 36-40 wt %

Ion exchange capacity: 1.6 mmol per gram of dry resin

### Example 11

### Preparation of an Exemplary Anion Exchange Membrane

To a solvent solution comprising a mixture of 156 g of diethylene glycol and 227 g of diethylene glycol methyl ether was added 210 g of the hydrophilic monomer MAPTAC and was gently stirred until the MAPTAC was dissolved. Then, 396 g of the hydrophobic cross-linking comonomer hexanediol diacrylate was mixed into the MAPTAC solution. After the mixture had dissolved into a homogenous solution, 11 g of Irgacure® 2959 was then stirred into and dissolved in the homogenous solution. The homogenous solution was applied onto a woven fabric comprising SEFAR® PET 1500 having the same properties disclosed in Example 1. Excess solution was removed from the substrate by running a roller over the substrate with care being taken to exclude air bubbles from the substrate. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic comonomer, resulting in the formation of a homogenous polymeric gel within, throughout, and about the woven fabric forming a homogenous membrane structure. The resulting membrane was rinsed thoroughly in water to remove excess diethylene glycol and diethylene glycol methyl ether, and then was placed into a 10% NaCl solution to enable ion exchange to convert the membrane into a chloride form, thereby converting the ion exchange membrane into an anion exchange membrane. The anion exchange membrane had the following properties:

Membrane thickness: 0.07 mm

Electrical resistance: 1.5 Ωcm²

Water content: 34-38 wt %

Ion exchange capacity: 1.5 mmol per gram of dry resin

### Example 12

### Preparation of an Exemplary Cation Exchange Membrane

A solvent solution was prepared by mixing together 231 g of dimethylacetamide with 77 g of tributylamine (3:1 ratio). To the 308-g solvent mixture was added 304 g of AMPS and mixed until it was dissolved. 114 g of hydrophobic cross-linking polyurethane oligomer diacrylate was diluted with 342 g of comonomer hexanediol diacrylate (ratio of 1:3), and then was added to the solvent solution already containing the AMPS component. The mixture was stirred to form a homogenous solution after which, 16 g of the photoinitiator Irgacure® 2959 was added and dissolved in the solvent mixture comprising the hydrophilic monomer and the hydrophobic cross-linking oligomers. The complete homogenous solution was applied onto a SEFAR® PET 1500 woven fabric. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in water and was then placed in 10% NaCl solution to enable ion exchange to convert the membrane into a sodium form, thereby converting the ion exchange membrane into a cation exchange membrane. The cation exchange membrane had the following properties:

Membrane thickness: 0.09 mm-0.10 mm

Electrical resistance: 2.0-3.0 Ωcm²

Water content: 25 wt %

Ion exchange capacity: 1.9 mmol per gram of dry resin

### Example 13

### Preparation of an Exemplary Cation Exchange Membrane

A solvent solution was prepared by mixing together 231 g of dimethylacetamide with 77 g of tributylamine (3:1 ratio). To the 308-g solvent mixture was added 304 g of AMPS and mixed until it was dissolved. 177 g of hydrophobic cross-linking polyurethane oligomer diacrylate was diluted with 531 g of comonomer hexanediol diacrylate (ratio of 1:3), and then was added to the solvent solution already containing the AMPS component. The mixture was stirred to form a homogenous solution after which, 20 g of the photoinitiator Irgacure® 2959 was added and dissolved in the solvent mixture comprising the hydrophilic monomer and the hydrophobic cross-linking oligomers. The complete homogenous solution was applied onto a SEFAR® PET 1500 woven fabric. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in water and was then placed in 10% NaCl solution to enable ion exchange to convert the membrane into a sodium form, thereby converting the ion exchange membrane into a cation exchange membrane. The cation exchange membrane had the following properties:

Membrane thickness: 0.09 mm-0.10 mm

Electrical resistance: 3.5-4.0 Ωcm²

Water content: 22 wt %

Ion exchange capacity: 1.4 mmol per gram of dry resin

### Example 14

### Preparation of an Exemplary Cation Exchange Membrane

A solvent solution was prepared by mixing together 231 g of dimethylacetamide with 77 g of tributylamine (3:1 ratio). To the 308-g solvent mixture was added 304 g of AMPS and mixed until it was dissolved. 76 g of hydrophobic cross-linking polyurethane oligomer diacrylate was diluted with 228 g of comonomer hexanediol diacrylate (ratio of 1:3), and then was added to the solvent solution already containing the AMPS component. The mixture was stirred to form a homogenous solution after which, 14 g of the photoinitiator Irgacure® 2959 was added and dissolved in the solvent mixture comprising the hydrophilic monomer and the hydrophobic cross-linking oligomers. The complete homogenous solution was applied onto a SEFAR® PET 1500 woven fabric. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in water and was then placed in 10% NaCl solution to enable ion exchange to convert the membrane into a sodium form, thereby converting the ion exchange membrane into a cation exchange membrane. The cation exchange membrane had the following properties:

Membrane thickness: 0.09 mm-0.10 mm

Electrical resistance: 1.2-1.5 Ωcm²

Water content: 35 wt %

Ion exchange capacity: 2.4 mmol per gram of dry resin

### Example 15

### Preparation of an Exemplary Cation Exchange Membrane

A solvent solution was prepared by mixing together 203 g of dimethylacetamide with 88 g of tributylamine (2.3:1 ratio). To the 291-g solvent mixture was added 304 g of AMPS and mixed until it was dissolved. 340 g of hydrophobic cross-linking polyester oligomer diacrylate was diluted with 113 g of comonomer hexanediol diacrylate (ratio of 3:1), and then was added to the solvent solution already containing the AMPS component. The mixture was stirred to form a homogenous solution after which, 15 g of the photoinitiator Irgacure® 2959 was added and dissolved in the solvent mixture comprising the hydrophilic monomer and the hydrophobic cross-linking oligomers. The complete homogenous solution was applied onto a SEFAR® PET 1500 woven fabric. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in water and was then placed in 10% NaCl solution to enable ion exchange to convert the membrane into a sodium form, thereby converting the ion exchange membrane into a cation exchange membrane. The cation exchange membrane had the following properties:

Membrane thickness: 0.09 mm-0.10 mm

Electrical resistance: 2.0-3.0 Ωcm²

Water content: 28 wt %

Ion exchange capacity: 1.9 mmol per gram of dry resin

### Example 16

### Preparation of an Exemplary Anion Exchange Membrane

To 360 g of hexanoic acid was added 210 g of the hydrophilic monomer 3-methacryloylaminopropyl trimethylammonium chloride (MAPTAC) and was gently stirred until the MAPTAC was dissolved. 70 g of the hydrophobic cross-linking polyurethane oligomer diacrylate was diluted with 140 g of hydrophobic cross-linking comonomer hexanediol diacrylate (ratio of 2:1), and then stirred into the MAPTAC solution. After the mixture had dissolved into a homogenous solution, 11 g of Irgacure® 2959 was then stirred into and dissolved in the homogenous solution. The homogenous solution was applied onto a SEFAR® PET 1500 woven fabric. Excess solution was removed from the substrate by running a roller over the substrate with care being taken to exclude air bubbles from the substrate. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in methanol to remove hexanoic acid solvent, and then was placed in 10% NaCl solution to enable ion exchange to convert the membrane into a chloride form, thereby converting the ion exchange membrane into an anion exchange membrane. The anion exchange membrane had the following properties:

Membrane thickness: 0.09-0.10 mm

Electrical resistance: 0.8-1.0 Ωcm²

Water content: 36-46 wt %

Ion exchange capacity: 2.3 mmol per gram of dry resin

### Example 17

### Preparation of an Exemplary Anion Exchange Membrane

To 360 g of hexanoic acid was added 210 g of the hydrophilic monomer 3-methacryloylaminopropyl trimethylammonium chloride (MAPTAC) and was gently stirred until the MAPTAC was dissolved. 245 g of the hydrophobic cross-linking polyurethane oligomer diacrylate was diluted with 245 g of hydrophobic cross-linking comonomer hexanediol diacrylate (at a ratio of 1:1), and then stirred into the MAPTAC solution. After the mixture had dissolved into a homogenous solution, 15 g of Irgacure® 2959 was then stirred into and dissolved in the homogenous solution. The homogenous solution was applied onto a SEFAR® PET 1500 woven fabric. Excess solution was removed from the substrate by running a roller over the substrate with care being taken to exclude air bubbles from the substrate. Excess homogenous solution was removed from the woven polyester cloth by running a roller over the fabric with care taken to remove and exclude air bubbles from the within and about the woven fabric thereby producing a homogenous solution impregnated woven fabric. The impregnated woven fabric was irradiated with UV light (wavelength 300-400 nm) for 8 min to initiate polymerization of the hydrophilic monomer and the hydrophobic oligomer and comonomer, resulting in the formation of a homogenous polymeric gel within, throughout, and about the woven fabric forming a homogenous membrane structure. The resulting membrane was rinsed thoroughly in methanol to remove hexanoic acid solvent, and then was placed in 10% NaCl solution to enable ion exchange to convert the membrane into a chloride form, thereby converting the ion exchange membrane into an anion exchange membrane. The anion exchange membrane had the following properties:

Membrane thickness: 0.09-0.10 mm

Electrical resistance: 3.5-4.0 Ωcm²

Water content: 36-34 wt %

Ion exchange capacity: 1.4 mmol per gram of dry resin

1. A process for producing a resilient ion exchange membrane impregnated with and covered by a homogenous cross-linked polymer, the process comprising:
selecting a porous matrix;
saturating the porous matrix with a homogenous solution comprising a mixture of:
(i) a hydrophilic ionic monomer,
(ii) a hydrophobic cross-linking oligomer and/or a hydrophobic cross-linking comonomer,
(iii) a free radical initiator, and
(iv) a solvent selected for dissolving and maintaining in the homogenous solution the hydrophilic ionic monomer, the hydrophobic cross-linking oligomer and/or the hydrophobic cross-linking comonomer, and the free radical initiator;
removing excess homogenous solution from the saturated porous matrix;
stimulating release of free radicals from the free radical initiator thereby initiating a polymerization reaction to form a homogenous cross-linked ion-transferring polymer filling the pores and covering the surfaces of the porous matrix thereby forming the resilient ion exchange membrane; and
washing the resilient ion exchange membrane to remove excess solvent.

2. The process of claim 1 further comprising bathing the washed resilient ion exchange membrane in a sodium chloride solution.

3. The process of claim 1, wherein the porous matrix is a material selected from a group consisting of a woven fabric, a non-woven sheet material, and a microporous substrate.

4. The process of claim 3, wherein the material is selected from a group consisting of polyesters, polyvinyl chlorides, low-density polyethylenes, very-low-density polyethylenes, polypropylenes, polysulfones, nylons, nylon-polyamides, and mixtures thereof.

5. The process of claim 4, wherein the material is a polyester material selected from a group consisting of polyglycolides, polyglycolic acids, polylactic acids, polycaprolactones, polyethylene adipates, polyhydroxyalkanoates, polyethylene teraphthalates, polybutylene teraphthalates, polytrimethylene teraphthalates, polyethylene naphthalates, and strands spun from a liquid crystal polymer formed by a polycondensation of a mixture of 4-hydroxybenzoic acid and 6-hydroxynaphthalene-2-carboxylic acid.

6. The process of claim 1, wherein the resilient ion exchange membrane is a cation exchange membrane.

7. The process of claim 6, wherein the homogenous solution comprises a hydrophilic ionic monomer selected from a group consisting of 2-acrylamido-2-methyl-1-propanesulfonic acid and salts thereof, sodium 4-vinylbenzenesulfonate, and 3-sulfopropyl acrylate potassium.

8. The process of claim 6, wherein the homogenous solution comprises 2-acrylamido-2-methyl-1-propanesulfonic acid or a salt of 2-acrylamido-2-methyl-1-propanesulfonic acid.

9. The process of claim 6, wherein the homogenous solution comprises a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, their dimethacrylate counterparts thereof, and mixtures thereof.

10. The process of claim 6, wherein the homogenous solution comprises a hydrophobic cross-linking oligomer and/or a hydrophobic cross-linking comonomer selected from a group consisting of polyurethane oligomers having three or more reactive vinyl groups, polyester oligomers having three or more reactive vinyl groups, polyether oligomers having three or more reactive vinyl groups, and mixtures thereof.

11. The process of claim 6, wherein the homogenous solution comprises a free radical initiator that releases free radicals upon stimulation with a stimulus selected from a group consisting of UV light irradiation, thermal radiation, electron beam radiation, and a redox reaction.

12. The process of claim 6, wherein the homogenous solution comprises a free radical initiator that releases free radicals upon irradiation with UV light, said free radical initiator selected from a group consisting of α-hydroxy ketones, benzoin ethers, benzil ketals, α-dialkoxy acetophenones, α-hydroxy alkylphenones, α-amino alkylphenones, acylphosphine oxides, benzophenons/amines, thioxanthone/amines, and titanocenes.

13. The process of claim 12, wherein the free radical initiator is selected from a group of α-hydroxy ketones consisting of 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, benzophenone, and mixtures thereof.

14. (canceled)

15. The process of claim 6, wherein the homogenous solution comprises a free radical initiator that releases free radicals upon exposure to thermal radiation, the free radical initiator selected from a group consisting of 1,1′-azobis(cyclohexanecarbonitrile), 2,2′-azobis(isobutyronitrile), 2,2′-azobis(4-methoxy-2.4-dimethyl valeronitrile), 2,2′-azobis(2.4-dimethyl valeronitrile), dimethyl 2,2′-azobis(2-methylpropionate), tert-amyl peroxybenzoate, benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peroxide, tert-butyl peracetate, cyclohexanone peroxide, dicumyl peroxide, and lauroyl peroxide.

16. The process of claim 6, wherein the solvent is selected from a group consisting of mixtures of dimethylacetamide and tributylamine, dimethylacetamide and trialkylamine, dimethylacetamide and dialkylamine, dimethylacetamide and monoalkylamine, and mixtures thereof.

17. The process of claim 16, wherein the solvent mixture consists of dimethylacetamide and tributylamine at a ratio selected from a range of about 1:3 (w/w) to about 5:1 (w/w).

18. The process of claim 16, wherein the solvent mixture consists of dimethylacetamide and trialkylamine at a ratio selected from a range of about 1:3 (w/w) to about 5:1 (w/w).

19. The process of claim 16, wherein the solvent mixture consists of dimethylacetamide and dialkylamine at a ratio selected from a range of about 1:3 (w/w) to about 5:1 (w/w).

20. The process of claim 16, wherein the solvent mixture consists of dimethylacetamide and monoalkylamine at a ratio selected from a range of about 1:3 (w/w) to about 5:1 (w/w).

21. The process of claim 6, wherein the homogenous solution comprises dimethylacetamide at a concentration selected from a range of about 20% by weight to about 45% by weight.

22. The process of claim 1, wherein the resilient ion exchange membrane is an anion exchange membrane.

23. The process of claim 22, wherein the homogenous solution comprises a hydrophilic ionic monomer selected from a group consisting of 3-methacryloylaminopropyl trimethylammonium chloride, vinylbenzyl trimethylammonium, 3-acrylamidopropyl trimethylammonium chloride, 2-acryloyloxyethyl trimethylammonium chloride, 3-methacryloylaminopropyl trimethylammonium chloride, and mixtures thereof.

24. The process of claim 22, wherein the homogenous solution comprises a hydrophobic cross-linking oligomer and/or a hydrophobic cross-linking comonomer selected from the group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, their dimethacrylate counterparts thereof, and mixtures thereof.

25. The process of claim 22, wherein the homogenous solution comprises a hydrophobic cross-linking oligomer and/or a hydrophobic cross-linking comonomer are selected from a group consisting of polyurethane oligomers having three or more reactive vinyl groups, polyester oligomers having three or more reactive vinyl groups, polyether oligomers having three or more reactive vinyl groups, and mixtures thereof.

26. The process of claim 22, wherein the homogenous solution comprises a free radical initiator that releases free radicals upon stimulation with a stimulus selected from a group consisting of UV light irradiation, thermal radiation, electron beam radiation, and a redox reaction.

27. The process of claim 22, wherein the homogenous solution comprises a free radical initiator that releases free radicals upon irradiation with UV light, said free radical initiator selected from a group consisting of α-hydroxy ketones, benzoin ethers, benzil ketals, α-dialkoxy acetophenones, α-hydroxy alkylphenones, α-amino alkylphenones, acylphosphine oxides, benzophenons/amines, thioxanthone/amines, and titanocenes.

28. The process of claim 27, wherein the free radical initiator is selected from a group of α-hydroxy ketones consisting of 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, benzophenone, and mixtures thereof.

29. (canceled)

30. The process of claim 22, wherein the homogenous solution comprises a free radical initiator that releases free radicals upon exposure to thermal radiation, the free radical initiator selected from a group consisting of 1,1′-azobis(cyclohexanecarbonitrile), 2,2′-azobis(isobutyronitrile), 2,2′-azobis(4-methoxy-2.4-dimethyl valeronitrile), 2,2′-azobis(2.4-dimethyl valeronitrile), dimethyl 2,2′-azobis(2-methylpropionate), tert-amyl peroxybenzoate, benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peroxide, tert-butyl peracetate, cyclohexanone peroxide, dicumyl peroxide, and lauroyl peroxide.

31. The process of claim 22, wherein the solvent is selected from a group of saturated aliphatic acids consisting of butyric acid, valeric acid, caprylic acid, capric acid, hexanoic acid, lauric acid, palmitic acid, stearic acid, arachidic acid, behenic acid, and mixtures thereof.

32. The process of claim 31, wherein the solvent comprises hexanoic acid at a concentration selected from a range of about 25% by weight to about 45% by weight.

33. The process of claim 22, wherein the solvent is selected from a group consisting of diethylene glycol, diethylene glycol methyl ether, and mixtures thereof.

34. A resilient cation exchange membrane produced by a process comprising:
selecting a porous matrix from a group consisting of a woven fabric, a non-woven sheet material, or a microporous substrate;
saturating the porous matrix with a homogenous solution comprising mixture of:
(i) a hydrophilic ionic monomer selected from a group consisting of 2-acrylamido-2-methyl-1-propanesulfonic acid and salts thereof, sodium 4-vinylbenzenesulfonate, and 3-sulfopropyl acrylate potassium,
(ii) a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, their dimethacrylate counterparts thereof, polyurethane oligomers having three or more reactive vinyl groups, polyester oligomers having three or more reactive vinyl groups, polyether oligomers having three or more reactive vinyl groups, and mixtures thereof,
(iii) a free radical intiator selected from, group consisting of 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, -hydroxy-cyclohexyl-phenyl-ketone:benzophenone, 1,1′-azobis(cyclohexanecarbonitrile), 2,2′-azobis(isobutyronitrile), 2,2′-azobis(4-methoxy-2.4-dimethyl valeronitrile), 2,2′-azobis(2.4-dimethyl valeronitrile), dimethyl 2,2′-azobis(2-methylpropionate), tert-amyl peroxybenzoate, benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peroxide, tert-butyl peracetate, cyclohexanone peroxide, dicumyl peroxide, and lauroyl peroxide, and
(iv) a solvent for dissolving and maintaining in a homogenous solution the hydrophilic ionic monomer, the hydrophobic cross-linking oligomer and/or the hydrophobic cross-linking comonomer, and the free radical initiator in a single phase mixture, wherein said solvent is one of dimethylacetamide or a mixture of dimethylacetamide and tributylamine at a weight ratio selected from a range of about 1:3 to about 5:1;
removing excess homogenous solution from the saturated porous matrix to form an impregnated porous matrix;
stimulating release of free radicals from the free radical initiator thereby initiating a polymerization reaction to form a cross-linked homogenous ion-transferring polymer substantially filling the pores and substantially covering the surfaces of the porous matrix thereby forming the resilient ion exchange membrane;
washing the resilient ion exchange membrane to remove excess solvent; and
bathing the resilient ion exchange membrane in a sodium chloride solution.

35.-36. (canceled)

37. A resilient anion exchange membrane produced by a process comprising:
selecting a porous matrix from a group consisting of a woven fabric, a non-woven sheet material, or a microporous substrate;
saturating the porous matrix with a homogenous solution comprising mixture of:
(i) a hydrophilic ionic monomer selected from a group consisting of 3-methacryloylaminopropyl trimethylammonium chloride, vinylbenzyl trimethylammonium, 3-acrylamidopropyl trimethylammonium chloride, 2-acryloyloxyethyl trimethylammonium chloride, 3-methacryloylaminopropyl trimethylammonium chloride, and mixtures thereof,
(ii) a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, dimethacrylate counterparts thereof, polyurethane oligomers having three or more reactive vinyl groups, polyester oligomers having three or more reactive vinyl groups, polyether oligomers having three or more reactive vinyl groups, and mixtures thereof,
(iii) a free radical intiator selected from, group consisting of 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, benzophenone, 1,1′-azobis(cyclohexanecarbonitrile), 2,2′-azobis(isobutyronitrile), 2,2′-azobis(4-methoxy-2.4-dimethyl valeronitrile), 2,2′-azobis(2.4-dimethyl valeronitrile), dimethyl 2,2′-azobis(2-methylpropionate), tert-amyl peroxybenzoate, benzoyl peroxide, 2,2-bis(tert-butylperoxy)butane, 1,1-bis(tert-butylperoxy)cyclohexane, 2,5-bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, tert-butyl hydroperoxide, tert-butyl peroxide, tert-butyl peracetate, cyclohexanone peroxide, dicumyl peroxide, and lauroyl peroxide, and
(iv) a solvent for solubilizing and maintaining the hydrophilic ionic monomer, the hydrophobic cross-linking oligomer and/or the hydrophobic cross-linking comonomer, and the free radical initiator in a single phase mixture, wherein said solvent is a saturated aliphatic fatty acid selected from caprylic acid, capric acid, hexanoic acid, lauric acid, palmitic acid, stearic acid, arachidic acid, behenic acid, and mixtures thereof;
removing excess homogenous solution from the saturated porous matrix to form an impregnated porous matrix;
stimulating release of free radicals from the free radical initiating thereby initiating a polymerization reaction to form a cross-linked homogenous ion-transferring polymer substantially filling the pores and substantially covering the surfaces of the porous matrix thereby forming the resilient ion exchange membrane;
washing the resilient ion exchange membrane to remove excess solvent; and
bathing the resilient ion exchange membrane in a sodium chloride solution.

38.-42. (canceled)

43. The resilient cation exchange membrane of claim 34, wherein the woven fabric is woven with strands selected from a group consisting of polyester, polyvinylchloride, low-density polyethylene, very-low-density polyethylene, polypropylene, polysulfone, nylon, nylon-polyamides, polyglycolic acid, polylactic acid, polycaprolactone, polyethylene adipate, polyhydroxyalkanoate, polyethylene teraphthalate, polybutylene teraphthalate, polytrimethylene teraphthalate, polyethylene naphthalate, a liquid crystal polymer formed by a polycondensation of 4-hydroxybenzoic acid and 6-hydroxynaphthalene-2-carboxylic acid, and combinations thereof.

44. The resilient cation exchange membrane of claim 34, wherein the non-woven sheet material is a single sheet or a lamination of two more sheets.

45. The resilient cation exchange membrane of claim 34, wherein the non-woven sheet material comprises a material selected from a group consisting of polyester, polyvinylchloride, low-density polyethylene, very-low-density polyethylene, polypropylene, polysulfone, nylonnylon-polyamides, polyglycolic acid, polylactic acid, polycaprolactone, polyethylene adipate, polyhydroxyalkanoate, polyethylene teraphthalate, polybutylene teraphthalate, polytrimethylene teraphthalate, polyethylene naphthalate, a liquid crystal polymer formed by a polycondensation of 4-hydroxybenzoic acid and 6-hydroxynaphthalene-2-carboxylic acid, and combinations thereof.

46. The resilient cation exchange membrane of claim 34, wherein the microporous substrate comprises a material selected from a group consisting of polyester, polyvinylchloride, low-density polyethylene, very-low-density polyethylene, polypropylene, polysulfone, nylon, nylon-polyamides, polyglycolic acid, polylactic acid, polycaprolactone, polyethylene adipate, polyhydroxyalkanoate, polyethylene teraphthalate, polybutylene teraphthalate, polytrimethylene teraphthalate, polyethylene naphthalate, a liquid crystal polymer formed by a polycondensation of 4-hydroxybenzoic acid and 6-hydroxynaphthalene-2-carboxylic acid, and combinations thereof.

47. The resilient anion exchange membrane of claim 37, wherein the woven fabric is woven with strands selected from a group consisting of polyester, polyvinylchloride, low-density polyethylene, very-low-density polyethylene, polypropylene, polysulfone, nylon, nylon-polyamides, polyglycolic acid, polylactic acid, polycaprolactone, polyethylene adipate, polyhydroxyalkanoate, polyethylene teraphthalate, polybutylene teraphthalate, polytrimethylene teraphthalate, polyethylene naphthalate, a liquid crystal polymer formed by a polycondensation of 4-hydroxybenzoic acid and 6-hydroxynaphthalene-2-carboxylic acid, and combinations thereof.

48. The resilient anion exchange membrane of claim 37, wherein the non-woven sheet material is a single sheet or a lamination of two more sheets.

49. The resilient anion exchange membrane of claim 37, wherein the non-woven sheet material comprises a material selected from a group consisting of polyester, polyvinylchloride, low-density polyethylene, very-low-density polyethylene, polypropylene, polysulfone, nylon, nylon-polyamides, polyglycolic acid, polylactic acid, polycaprolactone, polyethylene adipate, polyhydroxyalkanoate, polyethylene teraphthalate, polybutylene teraphthalate, polytrimethylene teraphthalate, polyethylene naphthalate, a liquid crystal polymer formed by a polycondensation of 4-hydroxybenzoic acid and 6-hydroxynaphthalene-2-carboxylic acid, and combinations thereof.

50. The resilient anion exchange membrane of claim 37, wherein the microporous substrate comprises a material selected from a group consisting of polyester, polyvinylchloride, low-density polyethylene, very-low-density polyethylene, polypropylene, polysulfone, nylon, nylon-polyamides, polyglycolic acid, polylactic acid, polycaprolactone, polyethylene adipate, polyhydroxyalkanoate, polyethylene teraphthalate, polybutylene teraphthalate, polytrimethylene teraphthalate, polyethylene naphthalate, a liquid crystal polymer formed by a polycondensation of 4-hydroxybenzoic acid and 6-hydroxynaphthalene-2-carboxylic acid, and combinations thereof.

51. A resilient cation exchange membrane comprising:
a porous matrix selected from a group consisting of polyesters, polyvinyl chlorides, low-density polyethylenes, very-low-density polyethylenes, polypropylenes, polysulfones, nylons, nylon-polyamides, and mixtures thereof;
said porous matrix impregnated with a cross-linked homogenous ion-transferring polymer that fills the pores and substantially covers the surfaces of the porous matrix;
said polymer formed by polymerizing:
(i) a hydrophilic ionic monomer selected from a group consisting of 2-acrylamido-2-methyl-1-propanesulfonic acid and salts thereof, sodium 4-vinylbenzenesulfonate, and 3-sulfopropyl acrylate potassium, with
(ii) a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, dimethacrylate counterparts thereof, polyurethane oligomers having three or more reactive vinyl groups, polyester oligomers having three or more reactive vinyl groups, polyether oligomers having three or more reactive vinyl groups, and mixtures thereof.

52. A resilient anion exchange membrane comprising:
a porous matrix selected from a group consisting of polyesters, polyvinyl chlorides, low-density polyethylenes, very-low-density polyethylenes, polypropylenes, polysulfones, nylons, nylon-polyamides, and mixtures thereof;
said porous matrix impregnated with a cross-linked homogenous ion-transferring polymer that fills the pores and substantially covers the surfaces of the porous matrix;
said polymer formed by polymerizing:
(i) a hydrophilic ionic monomer selected from a group consisting of 3-methacryloylaminopropyl trimethylammonium chloride, vinylbenzyl trimethylammonium, 3-acrylamidopropyl trimethylammonium chloride, 2-acryloyloxyethyl trimethylammonium chloride, 3-methacryloylaminopropyl trimethylammonium chloride, and mixtures thereof with
(ii) a hydrophobic cross-linking oligomer and/or a hydrophobic cross-linking comonomer selected from a group consisting of polyurethane oligomer diacrylate, polyester oligomer diacrylate, polyether oligomer diacrylate, epoxy oligomer diacrylate, polybutadiene oligomer diacrylate, silicone diacrylate, hexanediol diacrylate, decanediol diacrylate, dimethacrylate counterparts thereof, polyurethane oligomers having three or more reactive vinyl groups, polyester oligomers having three or more reactive vinyl groups, polyether oligomers having three or more reactive vinyl groups, and mixtures thereof.
